(19) United States
(12) Patent Application Publication
(10) Pub. No.: US 2017/0004530 A1
(43) Pub. Date: Jan. 5, 2017

(54) MERCHANT SPECIFIC OFFERS IN RESPONSE TO A USER QUERY

(71) Applicant: GOOGLE INC., Mountain View, CA (US)

(72) Inventors: Liang Ge, Sunnyvale, CA (US); Eun Yeong Ahn, San Jose, CA (US); Anand Murugappan, Milpitas, CA (US)

(21) Appl. No.: 14/755,644

(22) Filed: Jun. 30, 2015

(51) Int. Cl. G06Q 30/02

(52) U.S. Cl. CPC G06Q 30/0256; G06Q 30/0277

(57) ABSTRACT

Providing offers based on a search query comprises receiving and storing offers from merchants. The system identifies a potential merchant name from search query terms and identifies offers from a database that are not associated with the potential merchant name. The system compares the potential merchant name to the identified offers and determines if the potential merchant name appears in a number of the identified offers that is below a threshold. If so, the system determines that the query term identified as a potential merchant system is likely to be an actual merchant name. In this case, the offer distribution system may select only offers from the actual merchant to present to the user.

### TECHNICAL FIELD

The present disclosure relates to offer placement in response to a search query by determining if the search query is specific to a merchant and providing offers specific to that merchant which are thereby more relevant to the search query.

### BACKGROUND

In conventional systems, many online and other offer distributors receive offers from merchant systems, manufacturer systems, and other advertisers to be displayed or provided to a user based on user search queries. When a user searches for a product, the offer distribution system may provide advertisements and other offers that are related to that search query. For example, if a user searches for “shoes,” a search engine function of the offer distribution system may provide search results for “shoes.” In addition to the search results, the offer distribution system provides offers to the user that are related to shoes. For example, the offers may specify a merchant that sells shoes and/or a product that the merchant sells related to shoes. However, conventional systems cannot accurately identify whether a search query is specific to a particular merchant.

### SUMMARY

Techniques herein provide computer-implemented methods to provide merchant-specific offers based on a search query. An offer distribution system receives and stores one or more offers from multiple merchants. The system receives a query comprising one or more terms input by a user. The one or more terms comprise a name associated with a particular merchant. To determine that the name is associated with the particular merchant, the system first identifies the name of a merchant as a potential merchant name in the terms of the search query. Then, the system identifies one or more of the stored offers that are associated with merchants other than the potential merchant name and compares the name of the potential merchant with the identified offers. If the name of the potential merchant does not match any terms in the offers associated with the other merchants (or matches terms in less than a configurable number of offers), then the system determines that the name of the potential merchant is a name associated with the particular merchant. The system then communicates to the user one or more offers that are associated with the particular merchant and are responsive to the search query, while excluding offers from other merchants.

In certain other example aspects described herein, systems and computer program products to provide offers based on a search query are provided.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to provide merchant specific offers in response to a query, in accordance with certain example embodiments.

FIG. 2 is a block flow diagram depicting a method to provide merchant specific offers in response to a query, in accordance with certain example embodiments.

FIG. 3 is a block flow diagram depicting a method to receive and store offers from merchants, in accordance with certain example embodiments.

FIG. 4 is an illustration of an example offer database, in accordance with certain example embodiments.

FIG. 5 is a block diagram depicting a computing machine and a module, in accordance with certain example embodiments.

### DETAILED DESCRIPTION OF THE EXAMPLE EMBODIMENTS

### Overview

In an example embodiment, an offer distribution system receives a search query from a user. The offer distribution system identifies one or more of the search terms as a potential merchant name. The offer distribution system identifies stored offers that are not associated with the potential merchant name. The offer distribution system then compares the potential merchant name from the query to terms of the identified offers and determines if the potential merchant name matches terms in any of the identified offers. If the query term that is identified as a potential merchant name appears in a number of offers that is below a configurable threshold, then the offer distribution system determines that the query term identified as a potential merchant name is likely to be a name of an actual merchant. In this case, the offer distribution system selects only offers from the actual merchant to present to the user in response to the query.

The offer distribution system distributes offers to user computing devices based on search queries provided by the user. For example, if a user searches for one or more products, the offer distribution system provides sponsored results and other offers to the user computing device for display to the user. Merchants may compensate the offer distribution system for presenting the offers, based on factors such as a number of offers displayed on user computing devices, number of instances that a user clicks on or otherwise selects a provided offer, number of actions taken by a user that are related to the offer, or any other suitable factor. The offers created or submitted by the merchant may provide information with the offer that identifies the conditions required to redeem the offer, such as a specific product that must be purchased. The offers may provide a merchant name, a product name, an expiration date, and other suitable information.

In example embodiments, a manufacturer may represent an entity that manufacturers a product or a group of products under a brand. A merchant may represent an entity that markets or sells one or more products or brands of products to consumers. In an example, a manufacturer may produce a particular brand of shoes, while a merchant markets one or more brands of shoes, such as in a physical store, an online market, or in any suitable manner. Manufacturers and merchants operate manufacturing computing systems and merchant computing systems, respectively, to interact with the offer distribution system.

In an example embodiment, the offer distribution system receives offers from one or more merchants, manufacturers, or other product or service suppliers. Throughout this specification, the term “product” shall include products and/or services. The offer distribution system stores the received offers in a database or other suitable memory of the offer distribution system. The offer distribution system associates details of the stored offers with potential query terms, such as keywords or key phrases. For example, the offer distribution system may note that the offer pertains to categories, such as a particular product (for example, “shoes”), a particular brand (for example, “Elite Brand”), a discount amount (for example, “20% off”), a particular merchant name (for example, “Runner's Mart”), or any other suitable categories. The offers may be sorted and stored based on the merchant that provided the offers or with the merchant at which the offer is redeemable.

The offer distribution system receives a search query from a user computing device. The query may be related to a product, a brand, a merchant, a manufacturer, or any combination of these terms or other terms. The offer distribution system analyzes the search query and determines if the search query includes the name of a merchant. The determination may be based on a comparison of the search query terms with a database of known merchant names. For example, in a search query of “Runner's Mart shoes and hats,” the offer distribution system may determine that “Runner's Mart” is a potential merchant system name based on an appearance of the phrase “Runner's Mart” in a database of known merchant names. Any other manner of determining that a search query term is a potential merchant name may be employed.

In an example embodiment, the database of known merchant names may be created and stored by the offer distribution system. The database may include a list of merchant names that are associated with merchants that have provided offers to the offer distribution system. Alternatively, the database may be populated with merchant names based on data received from a web search or other data gathering techniques. The database may be insufficient for accurately determining if a potential merchant name is the name of an actual merchant without further applying the methods described herein. For example, the database may include a listing of a merchant name that is also a product or a brand name. In another example, the database may include a merchant name that is also a descriptive word or other generic term.

The offer distribution system compares the search query with the stored offers in the database of the offer distribution system. The offer distribution system removes offers associated with the potential merchant system name before the comparison. That is, the offer distribution system only compares the search query terms to offers associated with other merchants and not the potential merchant name identified from the search query.

If the potential merchant name is included in the offers of the comparison, then the offer distribution system determines that the term from the search query is most likely a product name, a brand or manufacturer name, a descriptive word, or other related term other than a merchant name. If the potential merchant name does not appear in any of the offers of the comparison, or only appears in a limited number of offers, then the offer distribution system determines that the potential merchant name is an actual merchant name being identified by the user.

For example, if a user provides a query with terms describing a brand such as “Elite Shoes,” then the offer distribution system may identify “Elite Shoes” as a potential merchant name because “Elite Shoes” may be categorized as a potential merchant and as a potential brand in the offer database. The offer distribution system removes offers associated with the potential merchant category of “Elite Shoes” and compares the search query with other offers from the database. The comparison to the offers in the database results in many offers for Elite Shoes from multiple merchants that also sell Elite Shoes. Thus, the offer distribution system determines that Elite Shoes is not an actual merchant name identified by the user, but is likely to be a brand, product, or a generic term.

Alternatively, if a user provides a query with the terms “Elite Shoes from Runner's Mart,” then the offer distribution system may also identify “Runner's Mart” as a potential merchant name because “Runner's Mart” may be categorized as a potential merchant in the offer database. The offer distribution system removes offers associated with the potential merchant category of “Runner's Mart” and compares the search query with other offers from the database. The comparison to the other offers in the database does not result in any offers with the terms “Runner's Mart” (or results in only a limited number of matches below a specified amount). In this case, the offer distribution system determines that Runner's Mart is an actual merchant name identified by the user because the name appears in only the merchant category associated with that merchant (or appears in only a limited number of matches below the specified amount).

Upon determining that a merchant name is provided in the query, the offer distribution system may provide one or a set of offers to the user computing device, with the offers being only from the merchant that was determined to be in the query. If the user entered a query that provided a merchant name, the offer distribution system determines that the user is likely to visit a physical or virtual location of that merchant. Thus, offers directed to the identified merchant would be of benefit to the merchant and the user.

By using and relying on the methods and systems described herein, the offer distribution system dynamically provides offers to users that are more relevant and pertinent. As such, the systems and methods described herein may be employed to allow primarily or exclusively offers from a particular merchant included in a search query to be presented to a user. For example, when a user inputs a query that includes a particular merchant name, the invention improves the offer results that may accompany the search query results. The offers are improved for the user in that the user receives more relevant offers. The offers are improved for the merchant in that offers are presented to users who are likely to patronize the merchant. The offers are improved for other merchants not cited in the query because offers from the other merchants are not presented to users that are likely to patronize the queried merchant and not the other merchants. Hence, the methods and systems described herein permit offers to be presented to users that are relevant, cost effective, accurate, and useful.

### Example System Architectures

Turning now to the drawings, in which like numerals represent like (but not necessarily identical) elements throughout the figures, example embodiments are described in detail.

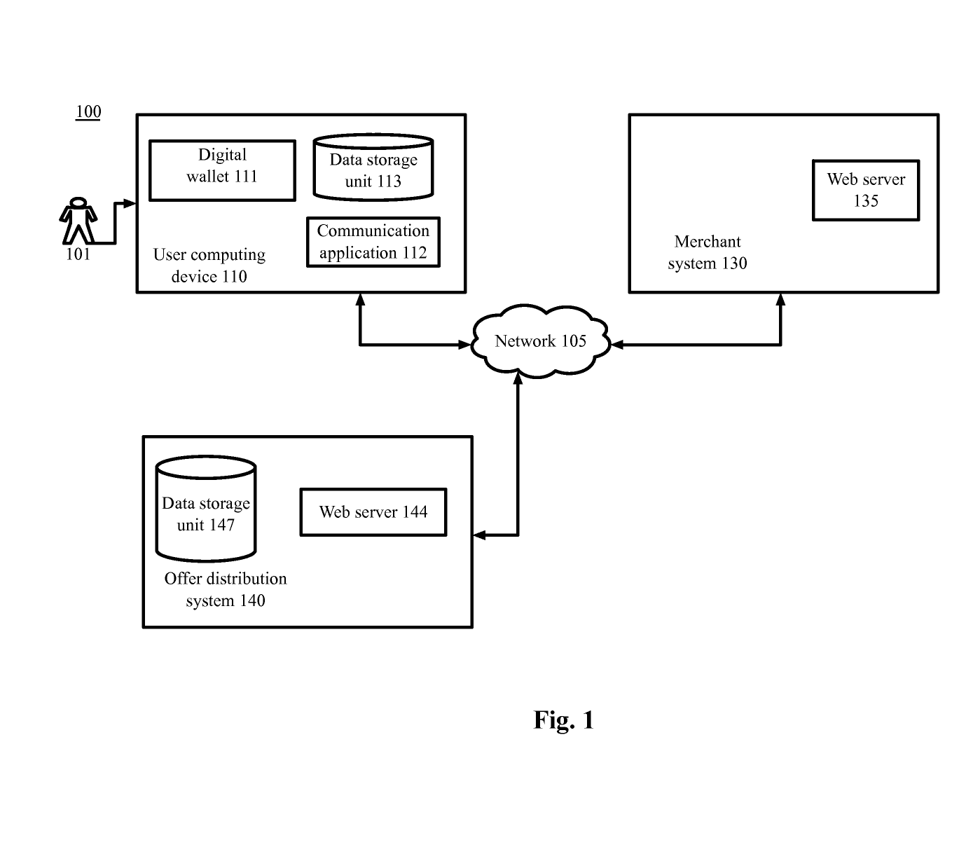

FIG. 1 is a block diagram depicting a system 100 to provide merchant specific offers in response to a query, in accordance with certain example embodiments. In some embodiments, a user associated with a device must install an application and/or make a feature selection to obtain the benefits of the techniques described herein.

As depicted in FIG. 1, the system 100 includes network computing devices 110, 130, and 140 that are configured to communicate with one another via one or more networks 105 or via any suitable communication technology.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 130, and 140 may be similar networks to network 105 or an alternative communication technology.

Each network computing device 110, 130, and 140 includes a computing device having a communication application capable of transmitting and receiving data over the network 105 or a similar network. For example, each network device 110, 130, and 140 can include a server, desktop computer, laptop computer, tablet computer, a television with one or more processors embedded therein and/or coupled thereto, smart phone, handheld or wearable computer, personal digital assistant (“PDA”), wearable devices such as smart watches or glasses, or any other wired or wireless, processor-driven device. In the example embodiment depicted in FIG. 1, the network devices 110, 130, and 140 are operated by end-users or consumers, merchant system operators, and offer distribution system operators, respectively.

The user 101 can use the communication application 112 on a user computing device 110, which may be, for example, a web browser application or a stand-alone application, to view, download, upload, or otherwise access documents or web pages via the network 105. The communication application 112 can interact with web servers or other computing devices connected to the network 105, including the web server 144 of the offer distribution system 140.

The user computing device 110 may include a digital wallet application 111. The digital wallet application 111 may encompass any application, hardware, software, or process the user computing device 110 may employ to assist the user 101 in completing a purchase. The digital wallet application 111 can interact with the communication application 112 or can be embodied as a companion application of the communication application 112. As a companion application, the digital wallet application 111 executes within the communication application 112. That is, the digital wallet application 111 may be an application program embedded in the communication application 112. In certain embodiments a digital wallet of the user 101 may reside in a cloud computing environment, on a merchant server, or in any other suitable environment.

The user computing device 110 also includes a data storage unit 113 accessible by the digital wallet application 111 and the communication application 112. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory devices or removable flash memory. In certain embodiments, the data storage unit 113 may reside in a cloud based computing system.

The offer distribution system 140 may include a data storage unit 147 accessible by the web server 144. The example data storage unit 147 can include one or more tangible computer-readable storage devices, or the data storage unit may be a separate system, such as, a different physical or virtual machine, or a cloud-based storage service. The offer distribution system 140 may include software or hardware that is operable to receive offers from merchants and manufacturers via the merchant systems 130, to select offers to appear in offer spots, to present offers to users, to record conversions of offers, to invoice merchant systems 130, and/or to perform other suitable functions.

The offer distribution system 140 may employ a search engine. The offer distribution system 140 may be a function of a search engine server, associated with a search engine server, or comprise a search engine application to conduct searches on a web page of the offer distribution system 140. The search engine may perform a search of the Internet, stored data, stored databases, or perform any other suitable search. The search engine may employ a third party search engine to perform the requested search. Any other suitable configuration for performing search queries associated with the offer distribution system 140 may be employed.

The user 101 may be provided with offers associated with the merchant system 130 and/or other merchant systems. The merchant system 130 depicted in FIG. 1 identifies a particular merchant system 130, even though the particular merchant system may be only one of a plurality of merchant systems. Additionally, as depicted in FIG. 1, the particular merchant system 130 represents the computing system operated by a particular merchant. The particular merchant system 130 may be one of a group of merchant systems that provide offers to the offer distribution system. Other merchant systems may provide offers in addition to the particular merchant system 130.

In an example embodiment, the merchant system 130 provides an offer to the offer distribution system 140. The offer is distributed to one or more users 101 via email, mobile ad, website advertising, or in any suitable manner. The merchant system 130 may upload an offer to the offer distribution system 140 for distribution, select an offer format from the offer distribution system 140, or in any suitable manner select an offer for distribution. The web server 135 may be used to store offers, create offers, communicate with the offer distribution system 140, or perform any suitable functions. The merchant system 130 may be associated with a retail store, an online store, a physical store location, a service provider, or any other suitable type of merchant system 130.

In certain embodiments, any function of the web server 144, or the offer distribution 140 may be performed by another function of the offer distribution system 140 or a third party system.

It will be appreciated that the network connections shown are examples and other means of establishing a communications link between the computers and devices can be used. Additionally, those having ordinary skill in the art and the benefit of this disclosure will appreciate that the merchant system 130, offer distribution system 140, and the user computing device 110 illustrated in FIG. 1 can have any of several other suitable computer system configurations. For example, a user computing device 110 embodied as a mobile phone or handheld computer may not include all of the components described above.

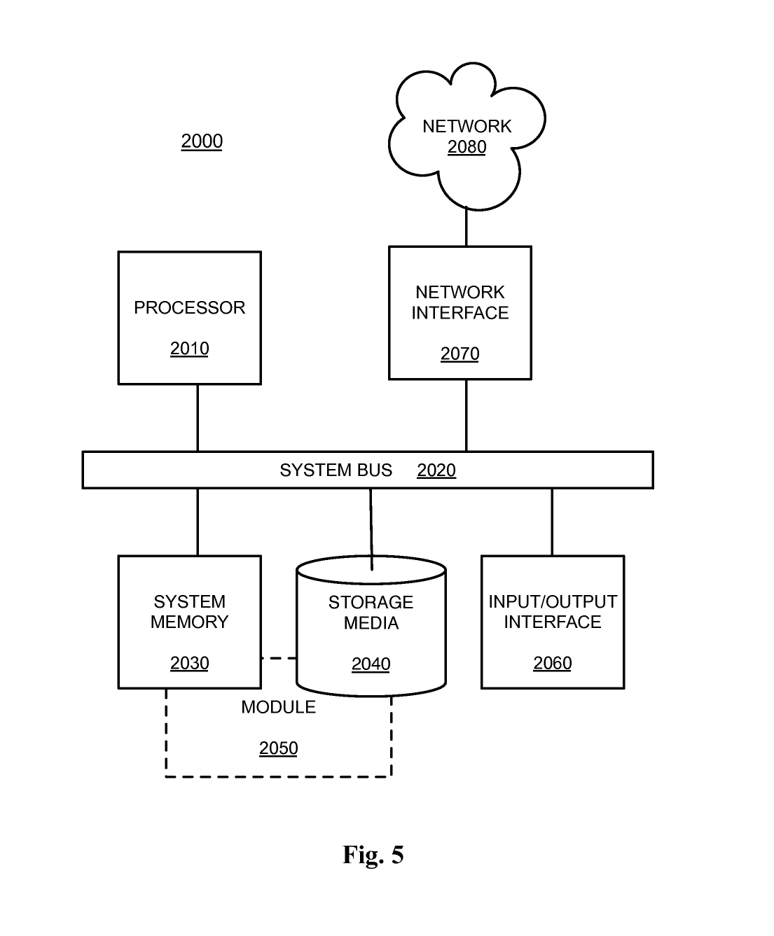

In example embodiments, the network computing devices and any other computing machines associated with the technology presented herein may be any type of computing machine such as, but not limited to, those discussed in more detail with respect to FIG. 5. Furthermore, any functions, applications, or modules associated with any of these computing machines, such as those described herein or any others (for example, scripts, web content, software, firmware, or hardware) associated with the technology presented herein may by any of the modules discussed in more detail with respect to FIG. 5. The computing machines discussed herein may communicate with one another, as well as with other computing machines or communication systems over one or more networks, such as network 105. The network 105 may include any type of data or communications network, including any of the network technology discussed with respect to FIG. 5.

### Example Processes

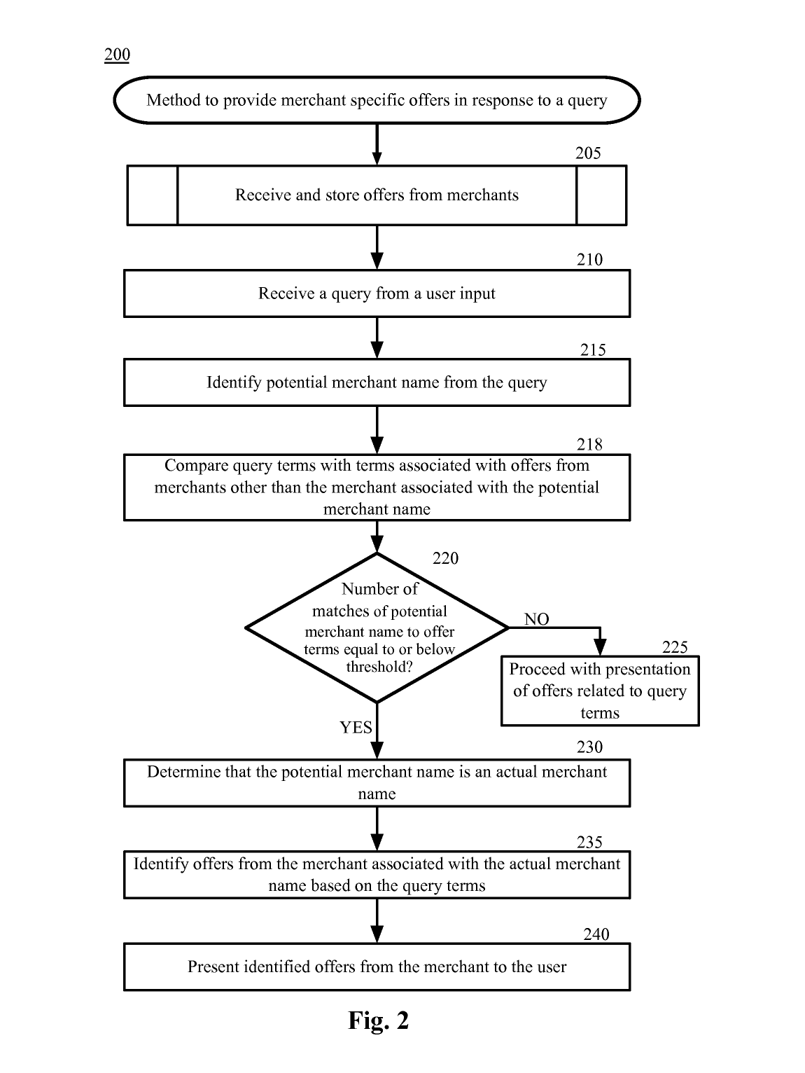

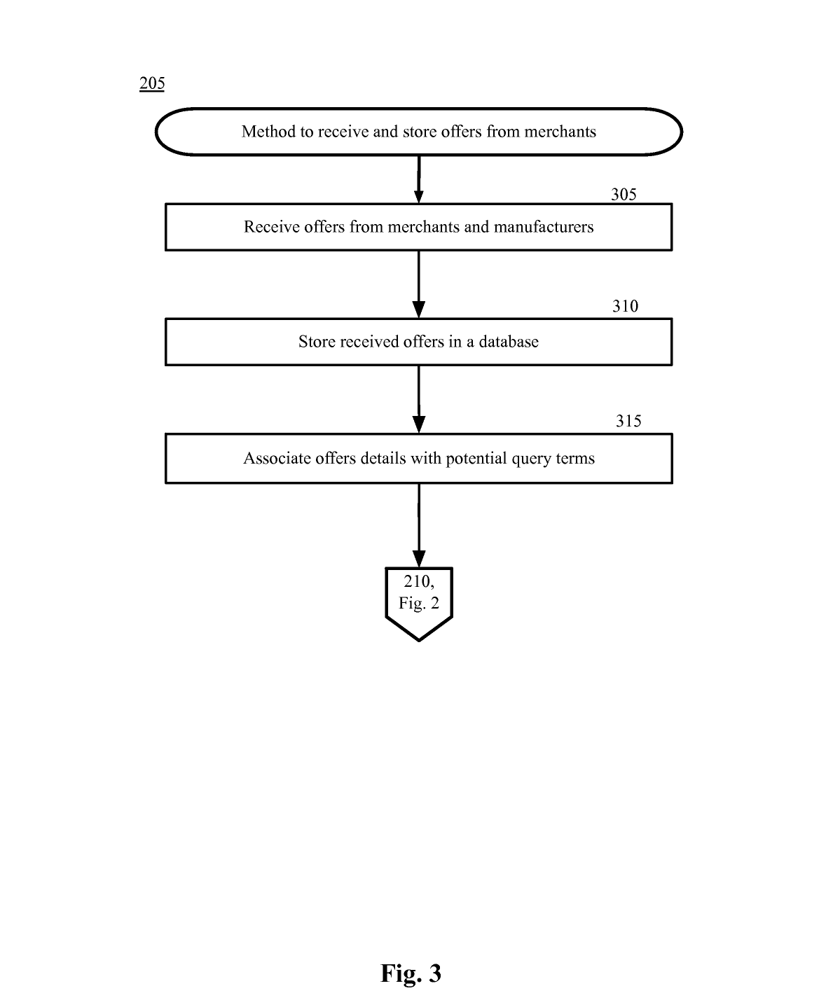

The example methods illustrated in FIGS. 2-3 are described hereinafter with respect to the components of the example operating environment 100. The example methods of FIG. 2-3 may also be performed with other systems and in other environments.

FIG. 2 is a block flow diagram depicting a method 200 to provide merchant specific offers in response to a query, in accordance with certain example embodiments.

With reference to FIGS. 1 and 2, in block 205, the offer distribution system 140 receives and stores offers from the merchant system 130 and other merchant systems. The details of block 205 are described in greater detail with respect to method 205 of FIG. 3.

FIG. 3 is a block flow diagram depicting a method 205 to receive and store offers from merchant systems, in accordance with certain example embodiments.

In block 305, the offer distribution system 140 receives offers from the merchant system 130 and other merchant systems. The merchant system 130 may be a particular one of a plurality of merchant systems. For example, the merchant system 130 may be one of a group of merchant systems that provide offers to the offer distribution system. Other merchant systems may provide offers to the offer distribution system 140 in addition to the particular merchant system 130.

The offer distribution system 140 receives offers from the merchant system 130 and other merchant systems via connections over the network 105, email, text, or via any suitable communication technology. In another example, the offer distribution system 140 designs and produces the offers based on conditions, terms, requests, and other desires of the merchant system 130. In an example, the offer may be an email offer to a user 101. In another example, the offer is a location-based alert or an offer to a mobile user computing device 110. In another example, the offer is an offer to be presented on a webpage, such as a pop-up advertisement or a banner advertisement. The offer may be presentable to a user computing device 110 in any suitable format. The offers may be any form of coupon, advertisement, rebate, or other suitable offer.

In operation, the offer distribution system 140 distributes offers to user computing devices 110 based on search queries provided by the user 101. For example, if a user 101 searches for one or more products, the offer distribution system 140 provides sponsored results and other offers to the user computing device 110 for display to the user 101. The merchant systems may compensate the offer distribution system 140 for displaying the offers based on factors such as a number of offers displayed on user computing devices 110, a number of instances that a user 101 clicks on or otherwise selects a provided offer, a number of actions taken by a user 101 that are related to the offer, or any other suitable factor. The offers created or submitted by the merchant systems may provide information with the offer that identifies the conditions required to redeem the offer, such as a specific product that must be purchased. The offers may provide a merchant name, a product name, an expiration date, and other suitable information for each particular offer.

In block 310, the offer distribution system 140 stores the received offers in a database of the data storage unit 147. The offers may be stored in categories related to the offers, such as by the name of the merchant associated with the merchant system 130 or other merchant systems, the type of discount or reward offered, the merchant category code of the merchant system 130, the type of product associated with the offer, the expiration date of the offer, or any other suitable category.

In block 315, the offer distribution system 140 associates offer details with potential query items, such as keywords. For example, a merchant associated with the merchant system 130, such as “Runner's Mart,” may provide an offer for a particular shoe brand. The offer may have details such as “20% off,” “Runner's Mart,” “Elite” brand, “Expiration—December 31,” and other details. The offer distribution system 140 may store the received offer in the database and associate categories with the database keywords, key phrases, merchant system names (such as “Runner's Mart”), shoe brand names (such as “Elite”), and other suitable details.

Offers may be categorized based on the merchant system 130 that provides the offers. For example, if Runner's Mart provides one or more offers to the offer distribution system 140, then the one or more offers may be stored in a category associated with the Runner's Mart name.

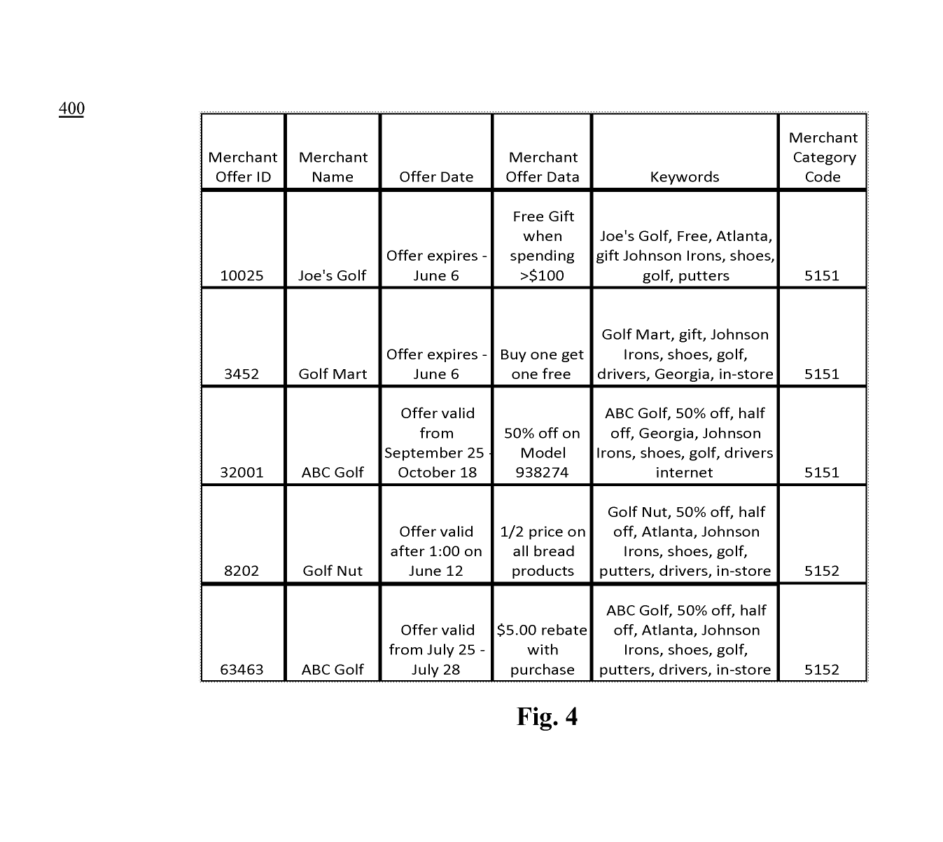

An example illustration of an example database 400 for storing offer details is shown in FIG. 4. In the example database, events are stored with the date range for a merchant offer ID, a merchant name, details of the offer, the date range for which the offer is active, keywords in the offer, and a merchant category code for the merchant.

Returning to FIG. 3, from block 315, the method 205 returns to block 210 of FIG. 2.

Returning to FIG. 2, in block 210, the offer distribution system 140 receives a search query from a user input into the user computing device 110. The query may be related to a product, a brand, a merchant name, a manufacturer of a product, or any combination of these terms or other terms. The query may be entered into a search engine or other “search” box on a search engine page, a shopping page, an offer distribution page, or any other search engine function displayed via the communication application 112 of the user computing device 110. The search query may be transmitted to the offer distribution system 140 from the user computing device 110 via a connection over the network 105, including via email, text, or any other suitable communication technology.

In block 215, the offer distribution system 140 identifies a name of a potential merchant from the search query. The offer distribution system 140 analyzes the search query and determines if the search query includes the potential name of a merchant. The determination may be based on a comparison of the search query terms with a database of known merchant names.

The database of known merchant systems may be created and stored by the offer distribution system 140. The database may include a list of merchant names that are associated with merchant systems that have provided offers to the offer distribution system. The database is insufficient for accurately determining if a potential merchant name is the name of an actual merchant without further applying the methods described herein. For example, the database may include a listing of a merchant name that is also a product or a brand name. In another example, the database may include a merchant name that is also a descriptive word or other generic term.

For example, in a search query of “Runner's Mart shoes and hats,” the offer distribution system 140 may determine that “Runner's Mart” is a potential merchant name based on an appearance of the phrase “Runner's Mart” in a database of known merchant systems. The offer distribution system 140 may compare the search query terms to known merchant names in the database and identify a match. If a match exists, then the query term is identified as a potential name of a merchant.

The determination may be based on any other factors analyzed by the offer distribution system 140. For example, the offer distribution system 140 may perform a search of one or more websites on the Internet to determine that the search query includes the name of a merchant. In another example, the offer distribution system 140 may analyze the categories of the offer database to determine the names of merchants that provided offers to the offer distribution system 140. That is, if one or more offers are provided to the offer distribution system 140 by a merchant, then the name of the entity that provided the one or more offers may be identified as a potential name of a merchant.

In block 218, the offer distribution system 140 compares terms of the search query with the stored offers in the database from merchants other than the potential merchant name. The offer distribution system 140 removes offers associated with the potential merchant name before the comparison.

That is, the offer distribution system 140 only compares the search query terms to offers associated with other merchants and not the potential merchant name identified in the search query. The offer distribution system 140 may sort the offers in the database based on the merchant system that provided the offers or based on the merchant system name identified in a list of categories of offers. The offer distribution system 140 may select any or all of the offers except for the offers associated with the potential merchant name. The offer distribution system 140 performs a comparison of the search query terms with terms or other details of the selected offers to identify offers that match one or more of the search query terms, such as the name of the potential merchant. The comparison may be made to the entirety of the contents of the selected offers, to the keywords identified in the selected offers, to the titles of the selected offers, to the merchant name of the selected offers, or to any subset of the data associated with the selected offers.

In an example, if a search query includes the term “coffee,” the offer distribution system 140 may determine that “coffee” is a potential merchant name because a group of offers exists from a merchant system 130 associated with a merchant having the name “Coffee.” The offer distribution system 140 removes the offers related to the merchant with the name “Coffee” and compares the search query to the remaining offers in the database. The term “coffee” in the example appears many times in the comparison because many of the other offers include the word “coffee.”

If the potential merchant name is repeated in the offers in the comparison, then the offer distribution system 140 determines that the term is not a specific merchant name, and may determine that the term is likely a product name, a brand or manufacturer name, or a descriptive term.

If the potential merchant name does not appear in any of the offers of the comparison, or only appears in a limited number of offers, then the offer distribution system 140 determines that the term is a name of a particular merchant. This process is discussed in more detail with reference to block 220.

In block 220, the offer distribution system 140 determines if the potential merchant name is associated with a number of offers below a threshold. In an example, an operator or other party configures the offer distribution system 140 with a threshold number of offers to use in the determination to determine if the potential merchant name is for a particular merchant. For example, the threshold for a number of offers may be 0, 1, 10, or 100. The threshold may be dependent on the total number of offers identified. For example, if a large number of offers are available, such as 5,000, then the threshold may be set to a higher number, such as 20. A lower number of total offers, such as 100, may allow the threshold to be set to a low number, such as 0, or 1, or 2. In a comparison with a large number of offers, a merchant name is more likely to randomly appear a larger number of times than in a comparison to a small number of offers.

The threshold may be set or revised based on a history of thresholds and the results each threshold produces. The threshold may be input into the offer distribution system 140 by the operator or other party, or the threshold may be produced by an algorithm or other software function that determines an appropriate threshold based on the search query, the name of the potential merchant, the number of available offers, and other suitable factors.

In an example where the threshold is zero, if only one offer has a term that matches the potential name of the merchant, then the number of matches is not equal to or less than the threshold.

A lower threshold results in a higher likelihood that the potential merchant name is a particular merchant name. Thus, the operator of the offer distribution system 140 may configure the threshold at a level to generate a desired level of precision in identifying particular merchant names. The operator may set a lower threshold to generate a higher precision in identifying particular merchant names. Alternatively, the operator may set a lower threshold to generate a relatively lower precision in identifying particular merchant names. And, the operator may set a threshold anywhere between the low and high thresholds to generate a corresponding desired level of precision.

In an example, if a user 101 provides a query with the terms “Elite shoes,” the offer distribution system 140 may identify “Elite” as a potential merchant name because “Elite” may be categorized as both a merchant and a brand in the offer database. The offer distribution system 140 removes offers associated with the merchant category of “Elite” and compares the search query with other offers from the database. The comparison to the other offers in the database results in many offers for Elite shoes from multiple merchants. Thus, the offer distribution system 140 determines that Elite is not an actual merchant system identified by the user, but is instead a likely brand or product. or descriptive term

Alternatively, if a user 101 provides a query with the terms “Elite shoes from Runner's Mart,” then the offer distribution system may identify “Runner's Mart” as a potential merchant name because “Runner's Mart” may be categorized as a merchant name in the offer database. The offer distribution system 140 removes offers associated with the merchant category of “Runner's Mart” and compares the search query with other offers from the database. The comparison to the other offers in the database does not result in any offers matching Runner's Mart (or results in a match of a number of offers below the set threshold). Thus, the offer distribution system 140 determines that Runner's Mart is an actual merchant name identified by the user 101.

In block 220, if the comparison does not result in a number of matches equal to or below the threshold, then the method 200 proceeds to block 225. In block 225, the offer distribution system 140 proceeds with presentation of offers related to the query terms without regard to a particular merchant system name. The offer distribution system 140 may present the offers based on a ranking of the relatedness of each offer with the query search terms. For example, if a greater number of the query search terms are associated with offer 1 than with offer 2, the offer distribution system 140 may rank offer 1 as being more related and present offer 1 as a higher ranked offer.

The offers may be communicated by the offer distribution system 140 to the user computing device 110 for presentation to the user 101 via the user computing device 110 in any suitable manner. For example, the offers may be a list of offers on a webpage showing the results of the search. In another example, the offers may be a pop-up advertisement or a banner advertisement. In another example, the offers may be emailed to the user computing device 110, texted to the user computing device 110, or transmitted in any suitable manner. In another example, the offers are associated with an offer account of the user 101 that is managed by the offer distribution system 140, the merchant system 130, or any other suitable offer management system.

Returning to block 220, if the comparison results in a number of matches equal to or below the threshold, the method 200 proceeds to block 230.

In block 230, the offer distribution system 140 determines that the query term for the potential merchant name is related to a name of the particular merchant. In an example, if the offer distribution system 140 determines that the query phrase “Runner's Mart” is matched with a number of other offers equal to or below the threshold, then the offer distribution system 140 determines that the phrase “Runner's Mart” is likely to be a name of a merchant. Conversely, the query phrase “Elite” may be repeated in a number of offers from many different merchant systems or manufacturers that is greater than the threshold. In this case, the offer distribution system 140 determines that it is unlikely that “Elite” is a name of a merchant system 130.

Returning to FIG. 2, in block 235, upon determining that a name of a merchant is provided in the query, the offer distribution system 140 provides a set of offers to the user computing device 110, where the offers are only from the merchant that was determined to be in the query. If the user 101 entered a query that provided a merchant name, the offer distribution system 140 determines that the user 101 would be likely to visit a physical or virtual location of that merchant system 130. Thus, offers directed to the identified merchant would be of benefit to the merchant system 130 and to the user 101.

In an example, if Runner's Mart is determined to be a merchant name in the search query, then the offer distribution system 140 identifies other offers related to Runner's Mart. For example, in addition to an offer for Elite shoes at Runner's Mart, the offer module 146 may provide other offers from Runner's Mart to the user computing device 110. For instance, other offers for other products related to Runner's Mart are provided. The other offers may be associated with Elite shoes, such as socks, or merely related to Runner's Mart.

In the example, a user 101 that searches for a brand, such as “Elite shoes” likely intends to purchase Elite shoes in the near future. This user 101 would likely enjoy offers from many merchant systems as the user decides where to shop for the shoes. However, a user 101 that searches for “Elite shoes at Runner's Mart” is likely intending to shop at Runner's Mart. The user 101 likely would only specify a particular merchant if the user 101 intended to patronize that particular merchant. If the user 101 is likely to shop at Runner's Mart, then it would be more productive for the offer distribution system 140 to provide offers related to Runner's Mart, even if those offers are not related to Elite shoes, than to provide offers for other merchant systems that are related to Elite shoes.

Returning to the example database 400 of FIG. 4, the database 400 is compared to a search query for “Joe's Golf Johnson Irons putters.” The offer distribution system 140 determines from a comparison to a database of merchant systems that Joe's Golf is likely to be a merchant system 130. The offer distribution system 140 removes offers related to Joe's Golf from the list of offers for the comparison. The search term Joe's Golf is compared to the remaining offers. In the example, the threshold number of matches is set at 1. The term “Joe's Golf” is determined, based on the comparison, not to match any terms in the list of offers. Thus, the term “Joe's Golf” is determined to be a name of a merchant system 130. Therefore, Joe's Golf is determined to be the merchant system 130 that is associated with the search query of the user 101. A similar process for the terms “Johnson Irons” and “putters” would determine that these terms are not the name of a merchant.

Returning to FIG. 2, in block 240, the offer distribution system 140 presents the offers from the merchant that are related to the query terms to the user computing device 110. Upon determining that a merchant name is included in the query, the offer distribution system 140 may provide a set of offers to the user only from the merchant that was provided in the query. The offers may be presented to the user 101 on the user computing device 110 in any suitable manner. For example, the offers may be a list of offers on a webpage showing the results of the search. In another example, the offers may be a pop-up advertisement or a banner advertisement. In another example, the offers may be emailed to the user computing device 110, texted to the user computing device 110, or transmitted in any suitable manner. In another example, the offers are associated with an offer account of the user 101 that is managed by the offer module 146, the merchant system 130, or any other suitable offer management system and accessed by the user 101 via the digital wallet application 111.

In certain examples, the offer distribution system 140 may present search results separate from the presentation of the offers. For example, while the offer distribution system 140 is performing the method 200, the offer distribution system 140 may be concurrently performing a search function based on the search query. The offer distribution system 140 may provide a search results document for the query based on a search of the Internet, a designated search location, such as a shopping database, or any other search engine designation. For example, if a user 101 enters a search query for Elite shoes, the search results may present webpages related to Elite shoes, shoes, or other related items.

In practice, the described method 200 results in significantly improved identification of merchant names in a search query. An identification of a merchant based on a simple comparison to a database or a search of the Internet results in an accurate identification of a particular merchant name in only approximately 13% of the attempts. Conversely, an identification of a merchant based on the methods and systems described herein results in an accurate identification of a particular merchant name in over 90% of the attempts. The significantly improved accuracy of the results indicates the effectiveness of the methods and systems described herein in identifying a particular merchant system 130 from a search term included in a search query.

### Example Systems

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to provide offers, comprising:
receiving, using one or more computing devices, one or more offers from a plurality of merchants;
storing in a database, using the one or more computing devices, the one or more offers from the plurality of merchants;
receiving, using the one or more computing devices, a query comprising one or more terms from a user computing device, the one or more terms comprising a name associated with a particular merchant;
identifying, using the one or more computing devices, the name associated with the particular merchant as a name of a potential merchant from the terms of the search query;
identifying, using the one or more computing devices, one or more of the offers from the database that are associated with merchants other than the potential merchant;
comparing, using the one or more computing devices, the name of the potential merchant with the identified offers;
determining, using the one or more computing devices, that the name of the potential merchant appears in a number of identified offers that is equal to or less than a configurable threshold;
determining, using the one or more computing devices, that the name of the potential merchant comprises a name associated with the particular merchant based on the determination that the name of the potential merchant appears in number of identified offers that is equal to or less than the configurable threshold; and
in response to determining that the name of the potential merchant comprises a name associated with the particular merchant, communicating, using the one or more computing devices, a set of offers that are associated with the particular merchant to the user computing device for presentation via the user computing device.

2. The computer-implemented method of claim 1, further comprising:
determining, using the one or more computing devices, that the name of the potential merchant appears in a number of offers that is greater than the configurable threshold;
determining, using the one or more computing devices, that the name of the potential merchant comprises a name associated with a particular brand; and
communicating, using the one or more computing devices, a set of offers that are associated with the particular brand from a plurality of merchants to the user computing device for presentation via the user computing device.

3. The computer-implemented method of claim 1, wherein the one or more offers from a plurality of merchants are stored on a database.

4. The computer-implemented method of claim 1, wherein the threshold number of offers is zero.

5. The computer-implemented method of claim 1, wherein the name of the particular merchant is determined to be a phrase of more than one word from the search query.

6. The computer-implemented method of claim 1, wherein the search query is a received input into a search engine interface associated with a shopping web page.

7. The computer-implemented method of claim 1, wherein the offers are communicated to the user computing device via an email.

8. The computer-implemented method of claim 1, wherein the offers are communicated to the user computing device via an advertisement on a web page displaying the results of the query.

9. A computer program product, comprising:
a non-transitory computer-readable storage device having computer-executable program instructions embodied thereon that when executed by a computer cause the computer to provide offers, the computer-executable program instructions comprising:
computer-executable program instructions receive to one or more offers from a plurality of merchants;
computer-executable program instructions to receive a query comprising one or more terms from a user computing device, the one or more terms comprising a name associated with a particular merchant;
computer-executable program instructions to identify the name associated with the particular merchant as a name of a potential merchant from the terms of the search query;
computer-executable program instructions to identify one or more of the offers from the database that are associated with merchants other than the potential merchant;
computer-executable program instructions to compare the name of the potential merchant with the identified offers
computer-executable program instructions to determine that the name of the potential merchant comprises a name associated with the particular merchant based on a determination that the name of the potential merchant appears in a number of identified offers that is equal to or less than a configurable threshold based on the comparison; and
computer-executable program instructions to communicate, in response to determining that the name of the potential merchant comprises a name associated with the particular merchant, one or more offers that are associated with the particular merchant to the user computing device for presentation via the user computing device.

10. The computer program product of claim 9, further comprising:
computer-executable program instructions to determine that the name of the potential merchant appears in a number of offers that is greater than the configurable threshold;
computer-executable program instructions to determine that the name of the potential merchant comprises a name associated with a particular brand; and;
computer-executable program instructions to communicate a set of offers that are associated with the particular brand from a plurality of merchants to the user computing device for presentation via the user computing device.

11. The computer program product of claim 9, wherein the cost is discounted to a configured amount equal to the second cumulative total plus a configured margin.

12. The computer program product of claim 9, wherein the threshold number of offers is zero.

13. The computer program product of claim 9, wherein the name of the particular merchant is determined to be a phrase of more than one word from the search query.

14. The computer program product of claim 9, further comprising computer-executable program instructions to store the one or more offers from a plurality of merchants.

15. A system to provide offers, comprising:
a storage resource; and
a processor communicatively coupled to the storage resource, wherein the processor executes application code instructions that are stored in the storage resource to cause the system to:
receive one or more offers from a plurality of merchants;
receive a query comprising one or more terms from a user computing device, the one or more terms comprising a name associated with a particular merchant;
identify the name associated with the particular merchant as a name of a potential merchant from the terms of the search query;
identify one or more of the offers from the database that are associated with merchants other than the potential merchant;
compare the name of the potential merchant with the identified offers;
determine that the name of the potential merchant comprises a name associated with the particular merchant based on a determination that the name of the potential merchant appears in a number of identified offers that is equal to or less than a configurable threshold; and
in response to determining that the name of the potential merchant comprises a name associated with the particular merchant, communicate one or more offers that are associated with the particular merchant to the user computing device for presentation via the user computing device.

16. The system of claim 15, wherein the cost is discounted to a configured amount equal to the second cumulative total plus a configured margin.

17. The system of claim 15, wherein the threshold number of offers is a single offer.

18. The system of claim 15, wherein the offers are communicated to the user computing device via an email.

19. The system of claim 15, further comprising application code instructions to store the one or more offers from a plurality of merchants.

20. The system of claim 15, wherein the offers are communicated to the user computing device via an advertisement on a web page displaying the results of the query.
